(19) United States
(12) Patent Application Publication
(10) Pub. No.: US 2014/0378048 A1
(43) Pub. Date: Dec. 25, 2014

(54) WIRELESS COMMUNICATION APPARATUS FOR VEHICLE AND WIRELESS COMMUNICATION METHOD BETWEEN RUNNING VEHICLES USING THE SAME

(71) Applicant: MANDO CORPORATION, Pyeongtaek-si (KR)

(72) Inventor: Jee Hoon KIM, Yongin-Si (KR)

(21) Appl. No.: 14/308,648

(22) Filed: Jun. 18, 2014

(30) Foreign Application Priority Data
Jun. 19, 2013 (KR) 10-2013-0070169

(51) Int. Cl. H04B 7/26; H04B 1/38

(52) U.S. Cl. CPC H04B 7/26; H04B 1/3822
USPC 455/39

(57) ABSTRACT

A wireless communication method between running vehicles includes steps of: receiving and collecting, by a wireless communication unit of a target vehicle, running information of a partner vehicle by communicating with a wireless communication unit of the partner vehicle; estimating, by a calculation unit of the target vehicle, a current distance from the partner vehicle through the collected running information of the partner vehicle; setting, by a control unit of the target vehicle, a transmission rate of communication data in correspondence with the current distance from the partner vehicle; monitoring, by the calculation unit of the target vehicle, a change in the distance from the partner vehicle; and changing, by the control unit of the target vehicle, the transmission rate of the communication data in correspondence with the change in the distance from the partner vehicle.

### BACKGROUND

1. Field of the Invention

The present invention relates to a wireless communication apparatus for a vehicle and a wireless communication method between running vehicles using the same, and more particularly, to a wireless communication apparatus for a vehicle and a wireless communication method between running vehicles using the same that enable smooth communication by changing a communication data transmission rate according to a distance from a partner vehicle.

2. Discussion of Related Art

Recently, research and development of technologies for wireless communication between running vehicles have been actively conducted. In addition, as wireless communication between vehicles is implemented, its utilization is expanding and derivative technologies related to the wireless communication between the vehicles are also expected to be variously provided.

The wireless communication between the vehicles as described above has a problem in that a reception rate is lower than that of general wireless communication technology because a relative distance continuously changes as target vehicles move in different directions at different speeds.

In particular, in the case of the conventional technology of wireless communication between vehicles, following transmission channel (modulation) is set to be changed up or down according to whether reception is successful when the wireless communication between the vehicles is performed. Accordingly, there is a problem in that a connection time delay according to a subsequent and sequential channel change is caused and a transmission rate is inefficiently degraded.

Accordingly, there is a need for a method of solving the above-described problems.

### CITATION LIST

### Patent Literature

(Patent Literature 1) Korean Patent No. 10-0571341

### SUMMARY OF THE INVENTION

An objective of the present invention is to provide a wireless communication apparatus for a vehicle and a wireless communication method between running vehicles using the same capable of shortening a connection time and improving a transmission rate.

It is to be understood that the technical problems to be solved by the present invention are not limited to the aforementioned problems and other technical problems which are not mentioned will be apparent to a person of ordinary skill in the art from the following description.

According to one aspect of the present invention, there is provided a wireless communication method between running vehicles, including steps of: receiving and collecting, by a wireless communication unit of a target vehicle, running information of a partner vehicle by communicating with a wireless communication unit of the partner vehicle; estimating, by a calculation unit of the target vehicle, a current distance from the partner vehicle through the collected running information of the partner vehicle; setting, by a control unit of the target vehicle, a transmission rate of communication data in correspondence with the current distance from the partner vehicle; monitoring, by the calculation unit of the target vehicle, a change in the distance from the partner vehicle; and changing, by the control unit of the target vehicle, the transmission rate of the communication data in correspondence with the change in the distance from the partner vehicle.

In addition, the step of changing the transmission rate of the communication data may include: changing the transmission rate of the communication data by changing transmission channel of the communication data.

In addition, the running information of the partner vehicle may include speed information of the partner vehicle, and the calculation unit of the target vehicle may estimate the distance from the partner vehicle through the speed information of the partner vehicle which is collected.

In addition, the running information of the partner vehicle may include Global Positioning System (GPS) information of the partner vehicle, and the calculation unit of the target vehicle may estimate the distance from the partner vehicle through the GPS information of the partner vehicle which is collected.

In addition, the wireless communication method may further include a step of: re-changing the transmission rate of the communication data when communication with the wireless communication unit of the partner vehicle fails after the step of changing the transmission rate of the communication data.

According to another aspect of the present invention, there is provided a wireless communication apparatus for a vehicle, including: a wireless communication unit provided to communicate with a wireless communication unit of a partner vehicle and configured to receive and collect running information of the partner vehicle; a calculation unit configured to estimate a current distance from the partner vehicle and a change in the distance from the partner vehicle through the collected running information of the partner vehicle; and a control unit configured to control a transmission rate of communication data in correspondence with the current distance from the partner vehicle.

### BRIEF DESCRIPTION OF THE DRAWINGS

The above and other objects, features and advantages of the present invention will become more apparent to those of ordinary skill in the art by describing in detail exemplary embodiments thereof with reference to the accompanying drawings, in which:

FIG. 1 is a diagram illustrating a structure of a wireless communication apparatus for a vehicle according to an exemplary embodiment of the present invention;

FIG. 2 is a flowchart illustrating steps of a wireless communication method between running vehicles using the wireless communication apparatus for the vehicle according to the exemplary embodiment of the present invention;

FIG. 3 is a diagram illustrating a state in which wireless communication between the running vehicles is performed in the wireless communication method between the running vehicles using the wireless communication apparatus for the vehicle according to the exemplary embodiment of the present invention;

FIG. 4 is a diagram illustrating a state in which wireless communication is performed when a distance between the running vehicles changes in the wireless communication method between the running vehicles using the wireless communication apparatus for the vehicle according to the exemplary embodiment of the present invention;

FIG. 5 is a graph illustrating a rate at which transmission is possible according to a distance between vehicles; and

FIG. 6 is a table illustrating transmission channel-specific transmission rates.

### DETAILED DESCRIPTION OF EXEMPLARY EMBODIMENTS

A wireless communication apparatus for a vehicle and a wireless communication method between running vehicles using the same according to an exemplary embodiment of the present invention will be described in detail below with reference to the accompanying drawings.

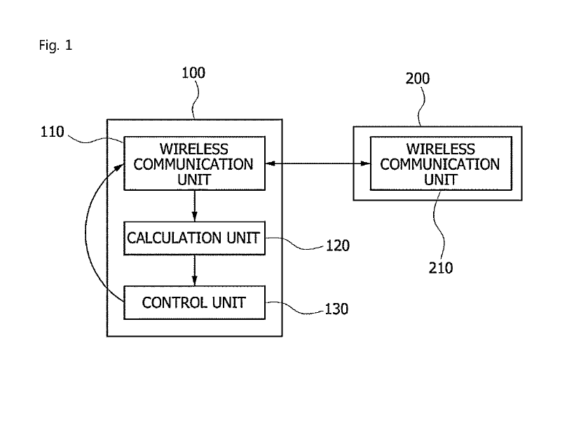

FIG. 1 is a diagram illustrating a structure of the wireless communication apparatus for the vehicle according to the exemplary embodiment of the present invention.

As illustrated in FIG. 1, the wireless communication apparatus for the vehicle according to the exemplary embodiment of the present invention includes a wireless communication unit 110, a calculation unit 120, and a control unit 130.

The wireless communication unit 110 is provided in a target vehicle 100 and configured to communicate with a wireless communication unit 210 of a partner vehicle 200 and receive running information of the partner vehicle 200. In this case, a type of wireless communication to be used is not limited. Because this is obvious to those skilled in the art, detailed description thereof is omitted.

In addition, the running information of the partner vehicle 200 may include various information such as speed information, GPS information, a vehicle model, hardware specs of a wireless communication unit, etc. of the partner vehicle 200.

The calculation unit 120 is a component for estimating a current distance from the partner vehicle 200 and a change in the distance from the partner vehicle 200 through the collected running information of the partner vehicle 200. That is, the calculation unit 120 finds a current position and speed of the target vehicle 100 and collects the running information of the partner vehicle 200, thereby calculating a current distance between the target vehicle 100 and the partner vehicle 200, a following distance change which is estimated, etc.

Of course, a following distance which is estimated may be continuously updated through the running information of the partner vehicle 200 transmitted in real time.

The control unit 130 is a component for controlling a transmission rate of communication data in correspondence with the current distance from the partner vehicle 200. That is, the control unit 130 can control the transmission rate of the communication data to be changed at the time of wireless communication through the distance from the partner vehicle 200 calculated through the wireless communication unit 110 and the calculation unit 120.

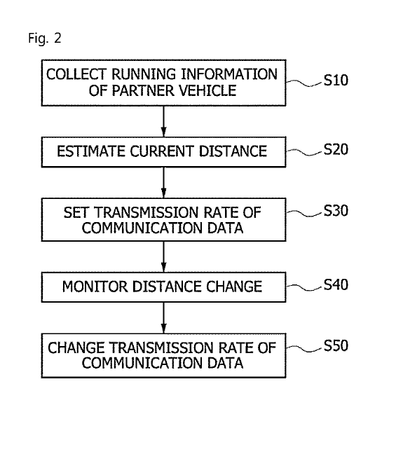

FIG. 2 is a flowchart illustrating steps of the wireless communication method between the running vehicles using the wireless communication apparatus for the vehicle according to the exemplary embodiment of the present invention.

As illustrated in FIG. 2, the wireless communication method between the running vehicles using the wireless communication apparatus for the vehicle according to the exemplary embodiment of the present invention includes step S10 of collecting running information of a partner vehicle, step S20 of estimating a current distance, step S30 of setting a transmission rate of communication data, step S40 of monitoring a distance change, and step S50 of changing the transmission rate of the communication data.

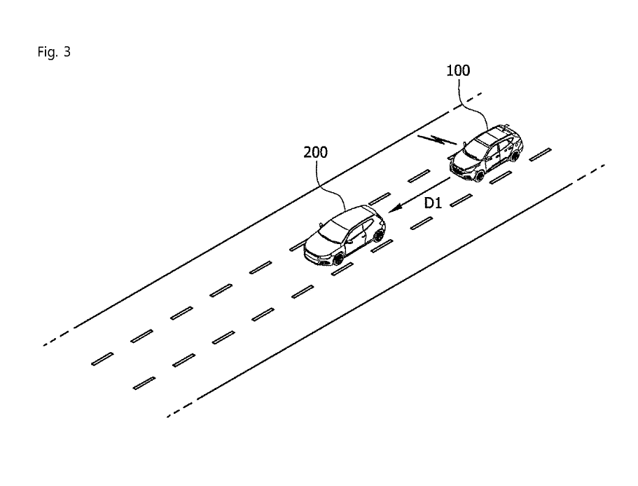

Step S10 of collecting the running information of the partner vehicle is the step of collecting the running information of the partner vehicle 200 separated by a first distance D1 from the current target vehicle 100 as illustrated in FIG. 3. In step S10, the wireless communication unit of the target vehicle 100 may receive and collect the running information of the partner vehicle 200 by communicating with the wireless communication unit of the partner vehicle 200.

Step S20 of estimating the current distance is the step in which the calculation unit of the target vehicle 100 estimates the current distance from the partner vehicle 200 through the collected running information of the partner vehicle 200. In this process, the calculation unit may calculate the first distance D1 through various running information.

In addition, in this step, the first distance D1 may be calculated through the speed information and GPS information of the running vehicle. This may be selectively defined according to a state or setting.

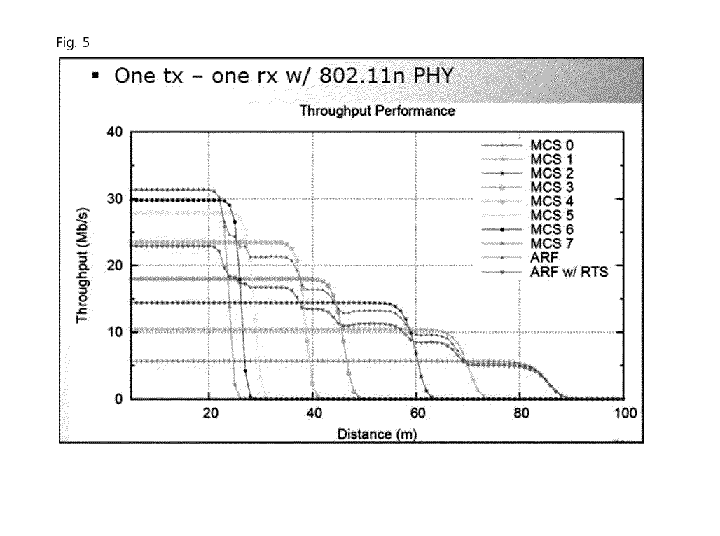

Step S30 of setting the transmission rate of the communication data is the step in which the control unit of the target vehicle 100 sets the transmission rate of the communication data in correspondence with the current distance. In step S30, it is possible to set a transmission rate most suitable for the current distance from the partner vehicle 200 based on data as illustrated in a graph illustrated in FIG. 5.

Step S40 of monitoring the distance change is the step in which the calculation unit of the target vehicle 100 monitors the change in the distance from the partner vehicle 200. In step S40, it is possible to calculate the distance change between the target vehicle 100 and the partner vehicle 200 in real time by continuously obtaining the running information of the partner vehicle 200 simultaneously when a following distance change is predicted based on the running information received from the partner vehicle 200.

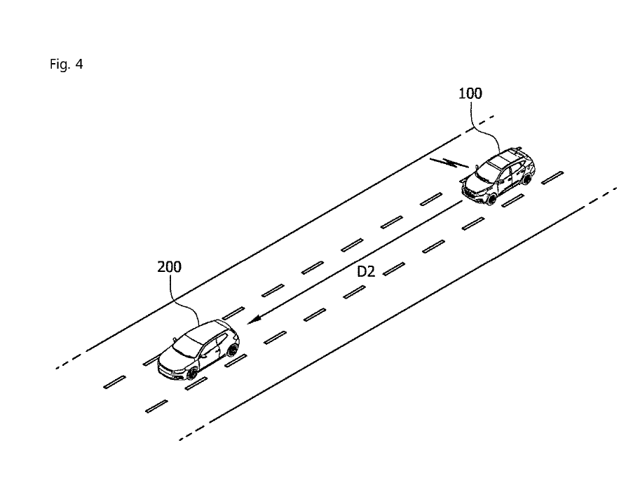

For example, when the distance between the target vehicle 100 and the partner vehicle 200 is assumed to change to a second distance D2 as illustrated in FIG. 4, the calculation unit may monitor and calculate the changed distance in the target vehicle 100.

Step S50 of changing the transmission rate of the communication data is the step in which the control unit of the target vehicle 100 changes the transmission rate of the communication data in correspondence with the change in the distance from the partner vehicle 200. In step S50, the transmission rate of the communication data is changed according to a changed separation distance.

Accordingly, it is possible to continuously perform optimized wireless communication between two vehicles according to the exemplary embodiment of the present invention.

On the other hand, the method may further include the step of re-changing the transmission rate of the communication data when communication with the wireless communication unit of the partner vehicle 200 fails after step S50 of changing the transmission rate of the communication data.

That is, when communication fails even after the communication rate has been changed according to a changed distance between two vehicles in this step, the transmission rate of the communication data may be re-changed by predicting the case in which an error occurs in a calculation result.

At this time, the change in the transmission rate may increase a communication restoration rate by making an up and down change in ascending order of absolute value of a transmission speed difference based on a transmission rate in which an error has currently occurred.

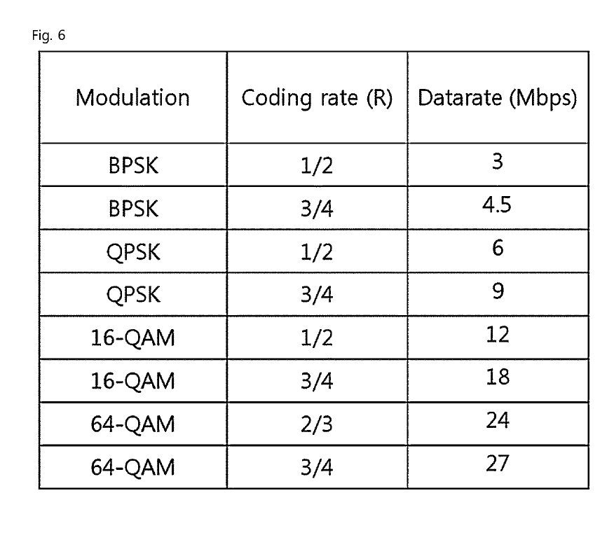

In addition, in step S50 of changing the transmission rate of the communication data, the transmission rate of the communication is assumed to be changed by changing transmission channel of the communication data. That is, because a coding rate and a data rate are allocated for every transmission channel as illustrated in FIG. 6, the transmission rate of the communication data may be changed by changing the transmission channel.

The wireless communication apparatus for the vehicle and the wireless communication method between running vehicles using the same according to the exemplary embodiment of the present invention are advantageous in that a connection rate of wireless communication between vehicles is improved because transmission channel is directly changed by estimating a distance from the partner vehicle and a relative distance.

Accordingly, there is an advantageous effect in that a time required for a connection is shortened.

In addition, there is an advantageous effect in that a transmission rate is also significantly improved.

The exemplary embodiments and the accompanied drawings of the present invention have been described for simply describing a part of the technical spirit of the present invention. Accordingly, the embodiments in the present specification have been described for the purpose of the illustration of the technical spirit of the present invention, not for the purpose of the limitation, so that those skilled in the art will appreciate that the scope of the technical spirit of the present invention is not limited by the described embodiments. Further, it shall be construed that all modifications and specific embodiments easily conceivable by those skilled in the art within the scope of the technical spirit included in the specification and drawings of the present invention belong to the scope of the right of the present invention.

1. A wireless communication method between running vehicles, comprising:
a step of receiving and collecting, by a wireless communication unit of a target vehicle, running information of a partner vehicle by communicating with a wireless communication unit of the partner vehicle;
a step of estimating, by a calculation unit of the target vehicle 100, a current distance from the partner vehicle 200 through the collected running information of the partner vehicle;
a step of setting, by a control unit of the target vehicle, a transmission rate of communication data in correspondence with the current distance from the partner vehicle;
a step of monitoring, by the calculation unit of the target vehicle, a change in the distance from the partner vehicle; and
a step of changing, by the control unit of the target vehicle, the transmission rate of the communication data in correspondence with the change in the distance from the partner vehicle.

2. The wireless communication method of claim 1, wherein the step of changing the transmission rate of the communication data includes:
changing the transmission rate of the communication data by changing transmission channel of the communication data.

3. The wireless communication method of claim 1,
wherein the running information of the partner vehicle includes speed information of the partner vehicle, and
wherein the calculation unit of the target vehicle estimates the distance from the partner vehicle through the speed information of the partner vehicle which is collected.

4. The wireless communication method of claim 1,
wherein the running information of the partner vehicle includes Global Positioning System (GPS) information of the partner vehicle, and
wherein the calculation unit of the target vehicle estimates the distance from the partner vehicle through the GPS information of the partner vehicle which is collected.

5. The wireless communication method of claim 1, further comprising a step of:
re-changing the transmission rate of the communication data when communication with the wireless communication unit of the partner vehicle fails after the step of changing the transmission rate of the communication data.

6. A wireless communication apparatus for a vehicle, comprising:
a wireless communication unit provided to communicate with a wireless communication unit of a partner vehicle and configured to receive and collect running information of the partner vehicle;
a calculation unit configured to estimate a current distance from the partner vehicle and a change in the distance from the partner vehicle through the collected running information of the partner vehicle; and
a control unit configured to control a transmission rate of communication data in correspondence with the current distance from the partner vehicle.
